(19) United States
(12) Patent Application Publication
(10) Pub. No.: US 2026/0339421 A1
(43) Pub. Date: Oct. 29, 2026

(54) SMART INTERACTION SYSTEM BASED ON SWIMMER STATE MONITORING

(71) Applicant: LG ELECTRONICS INC., Seoul (KR)

(72) Inventors: Seungjin JANG, Seoul (KR); Hyokune HWANG, Seoul (KR); Yongbeom MA, Seoul (KR); Namyoung KIM, Seoul (KR)

(73) Assignee: LG ELECTRONICS INC., Seoul (KR)

(21) Appl. No.: 19/110,987

(22) PCT Filed: Sep. 30, 2022
(86) PCT No.: PCT/KR2022/014775

§ 371 Date: Mar. 12, 2025

(51) Int. Cl. G06F 3/01; A63F 13/213; A63F 13/25; E04H 4/14; G01S 13/06; G01S 13/62; G01S 15/42; G01S 17/06; G01S 17/58

(52) U.S. Cl. CPC G06F 3/011; A63F 13/213; A63F 13/25; E04H 4/14; G01S 13/06; G01S 13/62; G01S 15/42; G01S 17/06; G01S 17/58; G06F 3/017

(57) ABSTRACT

The present invention relates to an interaction swimming pool system comprising: sensor modules, which sense one or more swimmer body parts through a water surface sensor module arranged on the surface of water and an underwater sensor module arranged under the water, so as to acquire first information and second information about the swimmer body parts; and a processor which generates position, height, gesture, and motion information about a swimmer by fusing, through a swimming sensor fusion algorithm, the first information and the second information that are input from first and second sensor modules, and which generates an event on the basis of the generated information, wherein the processor controls that an application execution screen corresponding to the generated event is output to a display.

### TECHNICAL FIELD

The present disclosure relates to a smart interaction system based on swimmer state monitoring. Specifically, the present disclosure relates to an interactive swimming pool system that monitors the position and state of a swimmer using a water surface sensor and an underwater sensor, and provides a service for increasing the fun and safety of a user based on a result of the monitoring.

### BACKGROUND ART

In the past, as a method for preventing a safety accident inside a swimming pool, a safety guard was deployed to monitor directly with his or her own eyes, or a visual monitoring method was used through a CCTV installed inside or outside the swimming pool.

However, in the case of direct monitoring by a safety guard, situations that the safety guard cannot check frequently occur due to noise or various other circumstances within the swimming pool. In addition, in the case of a physical monitoring method that checks multiple CCTVs simultaneously through vision, there are problems in that it takes a long period of time for CCTV monitors to determine an emergency or dangerous situation, it is difficult to monitor all screens and understand the situation, and it is difficult to understand a state of a swimmer located in the water.

In order to solve the foregoing problems, Korean Patent Publication No. 10-2015-0107966 proposes a wrist-worn drowning prevention monitoring device provided with an inertial sensor and a water sensor that detect the motion and environment of a user, but the prior art has a problem in that detection is limited to a person wearing the drowning prevention monitoring device.

In addition, in order to solve the problem of direct monitoring by a monitor through a CCTV screen, Korean Patent Publication No. 10-2065516 discloses a device that detects motion information of swimmers using an underwater camera, Korean Patent Publication No. 10-2406948 discloses a system that detects the position and motion of each swimmer through an imaging device disposed at a top of a swimming space and a safety management program, and Korean Patent Publication No. 10-2432675 proposes a system that collects CCTV footage from cameras disposed inside and outside a swimming pool, detects an abnormal human behavior, and transmits an alarm to a smartphone.

In addition, U.S. Patent Application Publication No. US20190087548A1 proposes a swimming pool monitoring system that monitors a state of a swimmer located on a water surface or in the water through a water surface and underwater monitoring device moving inside the swimming pool to prevent emergency accidents.

The foregoing prior arts monitor the position and motion of a user through an imaging device such as a camera to detect an abnormal behavior of a swimmer, thereby having an effect capable of sensing an emergency situation such as a drowning accident in real time and conducting rescue However, the prior arts disclose a method of monitoring the position and motion of a user by installing one or more imaging devices inside/outside a swimming space or in the water to detect an abnormal behavior of the user, which has a disadvantage in that it may cause a problem capable of violating the privacy of a swimmer.

### DISCLOSURE OF INVENTION

### Technical Problem

The present disclosure aims to solve the above-mentioned problems and other problems, and an aspect of the present disclosure is to provide an interactive swimming pool system of monitoring the position and state of a swimmer using a water surface sensor and an underwater sensor, and providing a service for increasing the fun and safety of a user based on a result of the monitoring, and a control method thereof.

### Solution to Problem

In order to achieve the foregoing and other objectives, according to an aspect of the present disclosure, an interaction swimming pool system according to an embodiment of the present disclosure may include a sensor module that senses a swimmer body part through a first sensor module above a water surface and a second sensor module below the water surface to acquire first and second information on the swimmer body part, and a processor that fuses the first and second information input from the first and second sensor modules to generate one or more of position, height, gesture and motion information on a swimmer, and generate an event based on the generated information, wherein the processor controls an application execution screen corresponding to the generated event to be output on a display.

In one embodiment, the first sensor module may be arranged above the water surface to sense one or more swimmer body parts located above the water surface, and acquire first information including body part identification information of the sensed swimmer body parts, coordinate information (x, y), and distance information from the water surface to the body parts, wherein the second sensor module is arranged below the water surface to sense one or more swimmer body parts located below the water surface, and acquire second information including coordinate information (x, y) of the sensed swimmer body parts and distance information from a bottom surface of a swimming pool to the sensed body parts.

In one embodiment, the processor may include a swimmer information generation module that fuses the first and second information input from the first and second sensor modules through a swimming sensor fusion algorithm to generate position, height, gesture and motion information on the swimmer including the sensed swimmer body parts, wherein the swimmer information generation module further generates swimmer identification information that identifies the swimmer.

In one embodiment, the system may further include a memory operatively coupled to the processor, wherein the processor controls swimmer information including the generated position, height, gesture and motion information on the swimmer and the swimmer identification information to be stored in the memory.

In one embodiment, the processor may further include a swimmer position monitoring module that monitors the position of the swimmer based on the swimmer information, and a swimmer state detection module that detects a state of the swimmer based on a result of the monitoring and the swimmer information, wherein the swimmer state detection module generates a predefined event based on the detected state of the swimmer, and the event includes notification information generated based on the detected state of the swimmer.

In one embodiment, the system may further include a communication module operatively coupled to the processor, wherein the processor controls notification information included in the event to be transmitted to a peripheral device through the communication module based on the generated event, and the peripheral device is at least one of electronic devices that control lighting, music and waves within the swimming pool.

In one embodiment, the first sensor module may include at least one sensor among a lidar sensor and a radar sensor, wherein the type, number, and arrangement of the one or more sensors are determined based on a sensing range of the sensor provided in the first sensor module and a size of the swimming pool.

In one embodiment, the first sensor module may calculates, when it is determined that the sensed body part is a head part of the swimmer based on body part identification information of the one or more sensed swimmer body parts, a swimmer head height, which is a distance from the water surface to the head part, calculate, when one or more other body parts are detected at a higher position than the head part, a swimmer peak height, which is a distance from the water surface to a highest body part, and further include the calculated swimmer head height and swimmer peak height in the first

In one embodiment, the second sensor module may be provided with at least one sensor among an optical sensor and an ultrasonic sensor, wherein the type, number, and arrangement of the one or more sensors are determined based on a sensing range of the sensor provided in the second sensor module and a size of the swimming pool.

In one embodiment, the second sensor module may include a vertical measurement underwater sensor disposed in a vertical direction with respect to one or more display panels provided on the display to sense one or more swimmer body parts located in the vertical direction of the display panels, a first inclination measurement underwater sensor disposed to be spaced apart from the vertical measurement underwater sensor and to be tilted in a first inclination angle direction so as to sense one or more swimmer body parts located in the first inclination angle direction, and a second inclination measurement underwater sensor disposed to be spaced apart from the first inclination measurement underwater sensor and to be tilted in a second inclination angle direction so as to sense one or more swimmer body parts located in the second inclination angle direction, wherein the vertical measurement underwater sensor, and the first and second inclination measurement underwater sensors are arranged in parallel to form one or more lines between the display panels.

In one embodiment, the second sensor module 120 may acquire, when the one or more sensed body parts are sensed by the first and second inclination measurement underwater sensors, distance information from a bottom surface of the swimming pool to the sensed body part based on a distance from the first and second inclination measurement underwater sensors to the sensed body part and the first and second inclination angles.

In one embodiment, the swimmer state detection module may count a number of swimmers located in the swimming pool based on a result of the monitoring and the swimmer information, calculate a swimming pool complexity based on a result of the counting, and generate notification information including the calculated swimming pool complexity to generate a predefined event.

In one embodiment, whether the swimmer is located in a specific area of the swimming pool having a depth suitable for the swimmer's height may be determined based on a result of the monitoring and the swimmer information, and notification information including swimmer identification information, position information of the swimmer, and a warning guidance message may be generated based on a result of the determination to generate a predefined event.

In one embodiment, the swimmer state detection module may determine whether the swimmer's stay period of time inside the pool exceeds a predefined suitable swimming period of time range based on a result of the monitoring and the swimmer information, and generate notification information including the swimmer identification information, position information, and a rest guidance message based on a result of the determination to generate a predefined event.

In one embodiment, the swimmer state detection module may determine whether the motion information included in the swimmer information matches a predefined swimmer abnormal motion pattern based on a result of the monitoring and the swimmer information, and generate notification information including swimmer identification information, position information, motion information of the swimmer, and a risk guidance message based on a result of the determination to generate a predefined event, wherein the swimmer abnormal motion pattern includes at least one of motion patterns of floundering, head submersion, full body submersion, and drowning in progress.

In one embodiment, the swimmer state detection module may determine whether the motion information included in the swimmer information matches a predefined game-related motion pattern in one or more game applications installed in the swimming pool system based on a result of the monitoring and the swimmer information, and generate notification information including swimmer identification information, position information, motion information of the swimmer, and the game application information based on a result of the determination to generate a predefined event, wherein the predefined game-related motion pattern includes a pattern in which a standing state of the swimmer, a jumping state, a state of waving his or her left or right hand, and a state of pressing a specific area where a game screen is displayed with his or her foot are detected in an area where the game screen of the game application is displayed.

In one embodiment, the display may include a first display and a second display, wherein one of the first and second displays is disposed in a form of a rooftop signage display, and the other one is disposed on a bottom surface of a swimming pool in a form of a flow signage display.

In one embodiment, the processor may further include an application control module that executes an application or a specific function of an application corresponding to the event based on the generated event, wherein the application control module controls an execution screen of the application to be output to at least one display among the first and second displays provided in the display.

In one embodiment, the system may further include an audio output module that outputs a notification sound corresponding to notification information included in an event generated by the processor.

In order to achieve the foregoing and other objective, according to an aspect of the present disclosure, a method of controlling an interaction swimming pool system according to an embodiment of the present disclosure may include sensing a swimmer body part through a first sensor module above a water surface and a second sensor module below the water surface to acquire first and second information on the swimmer body part, fusing the first and second information input from the first and second sensor modules to generate one or more of position, height, gesture and motion information on a swimmer, generating an event based on the generated information, and controlling an application execution screen corresponding to the generated event to be output on a display.

### Advantageous Effects of Invention

According to an embodiment of the present disclosure, the following effects may be achieved.

According to at least one of embodiments of the present disclosure, the present disclosure has an effect capable of providing an interactive swimming pool system of monitoring the position and state of a swimmer using a water surface sensor and an underwater sensor, and providing a service for increasing the fun and safety of a user based on a result of the monitoring, and

### BRIEF DESCRIPTION OF DRAWINGS

FIG. 1 is an internal block diagram of an interaction swimming pool system according to one embodiment of the present disclosure.

FIG. 2 is a conceptual diagram showing a configuration of an interaction swimming pool system according to one embodiment of the present disclosure.

FIG. 3 is a conceptual diagram showing a configuration of a first sensor module according to one embodiment of the present disclosure.

FIG. 4 is a conceptual diagram showing a configuration of a second sensor module by partially expanding area A in FIG. 3.

FIG. 5 is a conceptual diagram showing a sensing process of a first sensor module according to one embodiment of the present disclosure.

FIG. 6 is a conceptual diagram showing a sensing process of a second sensor module according to one embodiment of the present disclosure.

FIG. 7, which is a cross-sectional view showing a water surface sensor module in FIG. 3 from above, is a conceptual diagram showing a method of arranging the water surface sensor module.

FIGS. 8A to 8C, which are cross-sectional views showing an underwater sensor module in FIG. 2 from above, are conceptual diagrams showing a method of arranging the underwater sensor module.

FIG. 9 is a conceptual diagram illustrating a process of acquiring information on a swimmer head height and a swimmer peak height based on an image extracted by a water surface sensor module.

FIG. 10 is a conceptual diagram illustrating a process of acquiring distance information from a bottom surface of a swimming pool to a swimmer body part by an underwater sensor module.

FIG. 11 is an internal block diagram of a processor according to one embodiment of the present disclosure.

FIG. 12 is a block diagram showing an operation process of first and second sensor modules and a processor according to one embodiment of the present disclosure.

FIG. 13 is a conceptual diagram illustrating a process of calculating a swimmer's height through a swimming sensor fusion algorithm according to one embodiment of the present disclosure.

FIG. 14 is a conceptual diagram illustrating a process of calculating gesture information through a swimming sensor fusion algorithm according to one embodiment of the present disclosure.

FIG. 15 is a block diagram showing an operation process within a processor according to one embodiment of the present disclosure.

FIG. 16 is a conceptual diagram illustrating a process of detecting an abnormal state of a swimmer according to one embodiment of the present disclosure.

FIG. 17 is an exemplary diagram showing a game application according to one embodiment of the present disclosure.

FIG. 18 is a flowchart showing a control method of an interaction swimming pool system according to one embodiment of the present disclosure.

### MODE FOR THE INVENTION

Hereinafter, description for disclosed in this specification will be described in detail with reference to the accompanying drawings, wherein the same or similar elements will be denoted by the same reference numerals independent of the drawing numerals, and overlapping description of the same or similar elements will be omitted. The suffixes “module” and “unit” used for elements in the following description are used only to simplify the disclosure, and therefore do not have meanings or functions that distinguish elements from each other in themselves. In describing embodiments disclosed herein, moreover, the detailed description will be omitted when specific description for publicly known technologies to which the disclosure pertains is determined to obscure the gist of the present disclosure. Furthermore, the accompanying drawings are provided only for a better understanding of the embodiments disclosed herein and are not intended to limit technical concepts disclosed herein, and therefore, it should be understood that the accompanying drawings include all modifications, equivalents and substitutes within the concept and technical scope of the present disclosure.

The terms including an ordinal number such as first, second, and the like may be used to describe various elements, but the elements should not be limited by those terms. The terms are used merely for the purpose to distinguish one element from another element.

It should be understood that when an element is referred to as being “connected to” or “coupled to” another element, the element may be directly connected to or coupled to the other element or intervening elements may also be present. On the contrary, it should be understood that when it is mentioned herein that an element is “directly connected” or “directly coupled” to another element, a still another element may not be present therebetween.

A singular representation may include a plural representation, unless The terms “include” or “have” used herein should be understood that they are intended to indicate the presence of a feature, a number, a step, an operation, an element, a component or a combination thereof disclosed in the specification, and it may also be understood that the presence or additional possibility of one or more other features, numbers, steps, operations, elements, components or combinations thereof are not excluded in advance.

An electronic device described in this specification may be applied to a stationary terminal such as a digital TV, a desktop computer, a kiosk, a digital signage, and the like. In particular, the electronic device described in this specification may be applied to a non-contact display device, that is, an image display device, such as a kiosk, a digital signage, and the like.

Hereinafter, a configuration of an interaction swimming pool system according to an embodiment of the present disclosure will be described in detail with reference to the accompanying drawings.

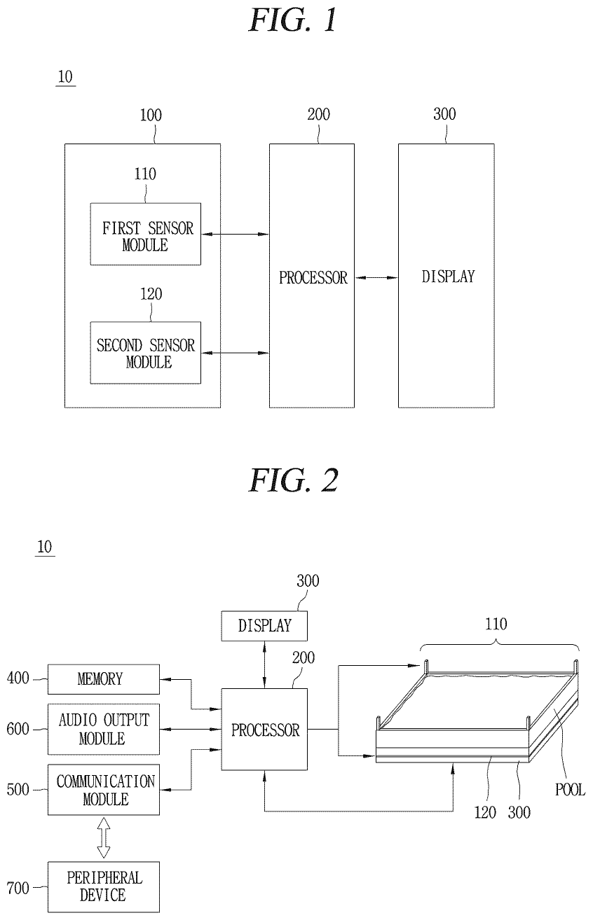

Referring to FIG. 1, an interaction swimming pool system 10 according to an embodiment of the present disclosure may include a sensor module 100 including a first sensor module 110 and a second sensor module 120, a processor 200, and a display 300.

However, the elements shown in FIG. 1 are not essential for implementing the interaction swimming pool system 10, and thus the interaction swimming pool system 10 described in this specification may have more or fewer elements than those listed above.

FIG. 2 is a conceptual diagram showing a configuration of the interaction swimming pool system 10 according to an embodiment of the Referring to FIG. 2, the interaction swimming pool system 10 according to an embodiment of the present disclosure may include a first sensor module 110 arranged above a water surface, a second sensor module 120 arranged below the water surface, a processor 200, a display 300, and a memory 400.

In addition, the display 300 may be provided with one or more displays, at least one of the one or more displays may be arranged in a form of a rooftop signage display, and at least another one may be arranged on a bottom surface of a swimming pool in a form of a flow signage display, but is not limited thereto.

For convenience of explanation below, a display arranged in the form of the rooftop signage display is referred to as a first display, and a display arranged on a bottom surface of the swimming pool in the form of the flow signage display is referred to as a second display.

In addition, the interaction swimming pool system 10 according to an embodiment of the present disclosure may further include a communication module 500 and an audio output module 600 operatively coupled to the processor 200, and the processor 200 may control a peripheral device 700 within the swimming pool through the communication module 500. Specifically, the peripheral device 700 may denote one or more electronic devices that control lighting, music, and waves within the swimming pool, but is not limited thereto.

Meanwhile, the communication module 500 included in the interaction swimming pool system 10 according to an embodiment of the present disclosure may include one or more modules that allow wireless communication between the interaction swimming pool system 10 and at least one peripheral device, or between an external server, but is not limited thereto.

In addition, the communication module 500 may include one or more modules that connect the interaction swimming pool system 10 to one or more networks.

The module included in the communication module 500 may include a wireless Internet module. The wireless Internet module refers to a module for wireless Internet access, which may be built into or external to the interaction swimming pool system 10. The wireless Internet module may be configured to transmit and receive a wireless signal in a communication network according to wireless Internet technologies.

The wireless Internet technologies may include, for example, wireless LAN (WLAN), wireless-fidelity (Wi-Fi), wireless-fidelity direct (Wi-Fi Direct), digital living network alliance (DLNA), wireless broadband (WiBro), worldwide interoperability for microwave access (WiMAX), high speed downlink packet access (HSDPA), high speed uplink packet access (HSUPA), long term evolution (LTE), long term evolution-advanced (LTE-A), and the like, and may also include Internet technologies not listed above. Furthermore, data may be transmitted and received according to at least one wireless Internet technology in a range not listed above.

In addition, the module included in the communication module 500 may include a short-range communication module. The short-range communication module is configured to facilitate short-range communication, which can support short-range communication using at least one of Bluetooth™, radio frequency identification (RFID), infrared data association (IrDA), ultra wideband (UWB), ZigBee, near field communication (NFC), wireless-fidelity (Wi-Fi), Wi-Fi direct, wireless universal serial bus (wireless USB) technologies, and the like. The short-range communication module may support wireless communication between the interaction swimming pool system 10 and at least one other peripheral device through short-range wireless communication networks.

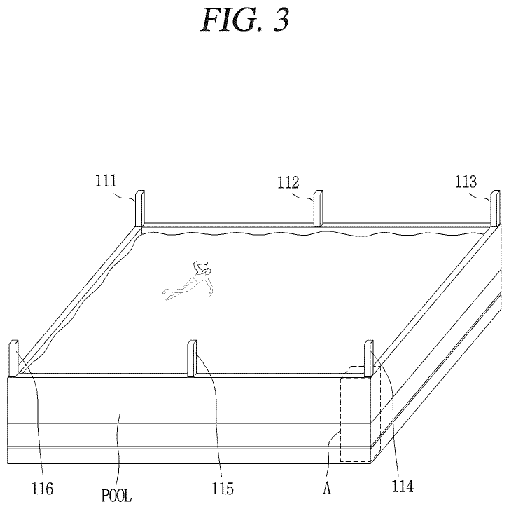

Hereinafter, the configuration of the sensor module 100 according to an embodiment of the present disclosure will be described in detail with reference to FIGS. 3 to 10.

Referring to FIG. 3, a plurality of sensors 111 to 116 provided in the first sensor module 110 may be arranged above a water surface to sense a swimmer's body part protruding above the water surface, but is not limited thereto.

For convenience of explanation below, a first sensor module 110 arranged above the water surface is referred to as a ‘water surface sensor module’, and a plurality of sensors provided in the water surface sensor module 110 are referred to as ‘water surface sensors’.

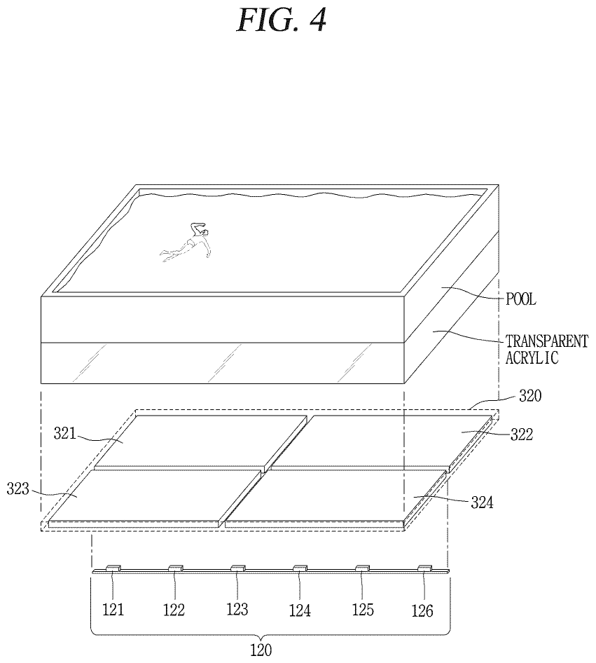

FIG. 4 is a conceptual diagram partially expanding area A in FIG. 3. When describing the configuration of the second sensor module 120 with reference to FIG. 4, a plurality of sensors 121 to 126 provided in the second sensor module 120 may be arranged below the water surface to sense a swimmer body part located below the water surface. In addition, the second sensor module 120 may be located above or below a transparent acrylic located below the pool depending on the type of sensor provided in the second For convenience of explanation below, a second sensor module 120 arranged below the water surface is referred to as an ‘underwater sensor module’, and a plurality of sensors provided in the underwater sensor module 120 are referred to as ‘underwater sensors’.

Referring again to FIG. 4, a display 320 according to an embodiment of the present disclosure may include a plurality of display panels 321 to 324, but is not limited thereto.

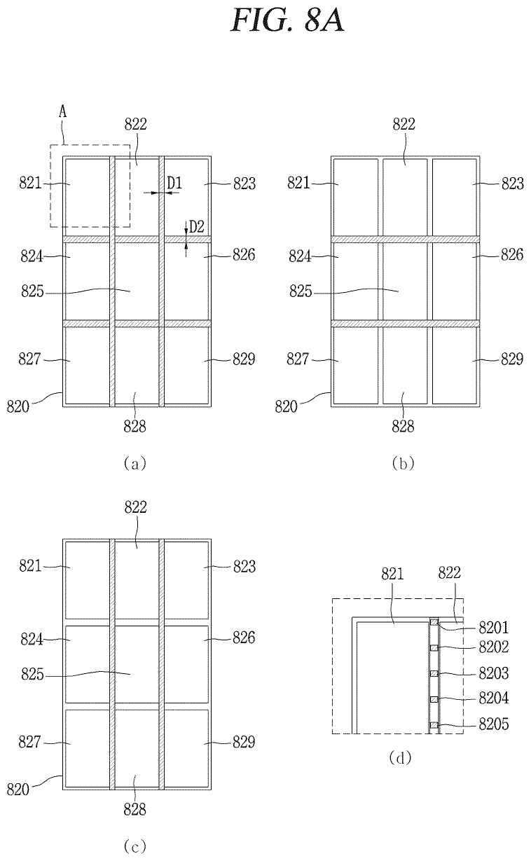

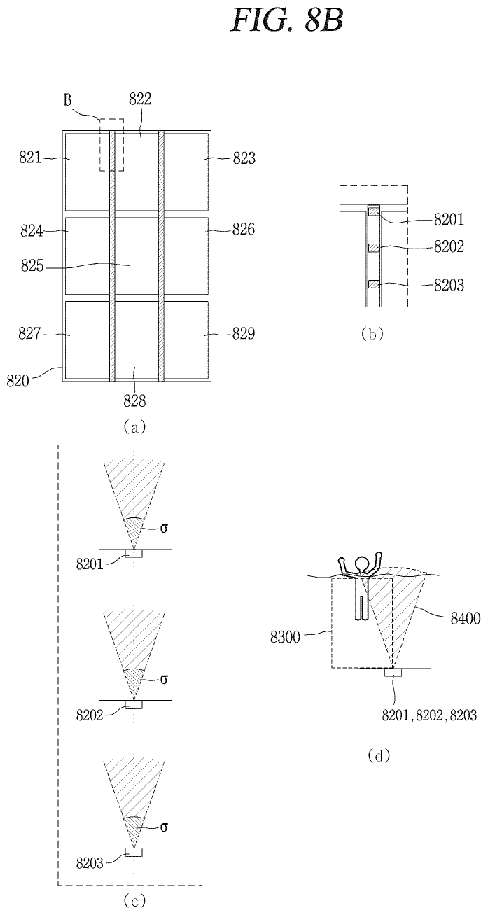

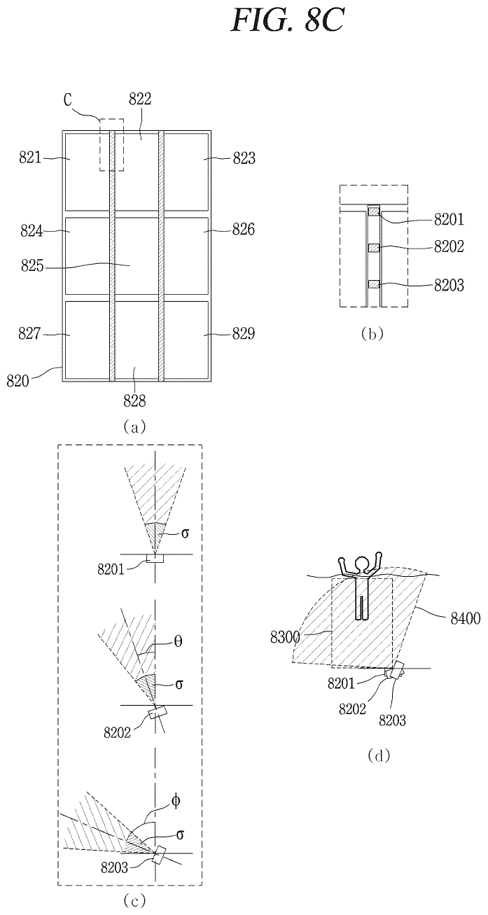

As shown in FIG. 4, a plurality of underwater sensors 121 to 126 provided in the underwater sensor module 120 may be arranged in parallel to form one or more lines in a horizontal direction or vertical direction between the plurality of display panels 321 to 324 so as not to cover the plurality of display panels 321 to 324, but are not limited thereto. A more specific method of arranging the foregoing underwater sensor module 120 will be described in detail in FIGS. 8A to 8C.

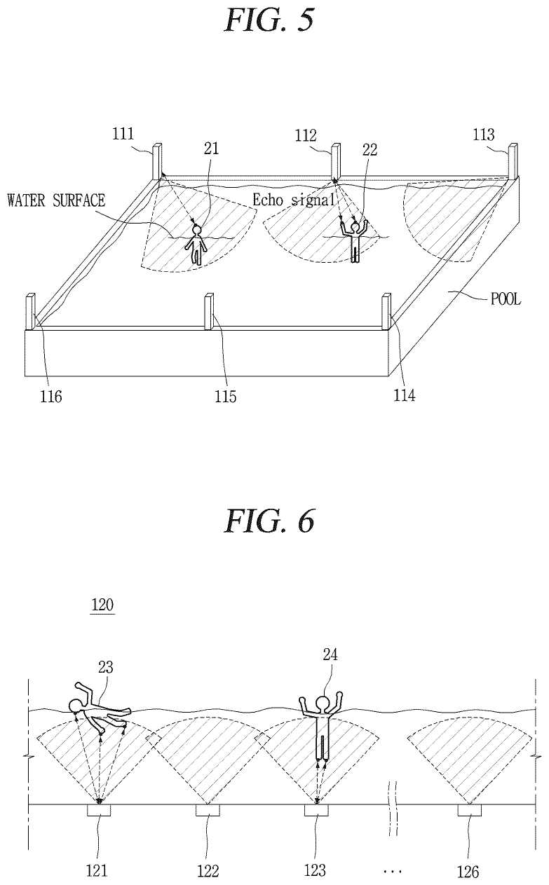

Referring to FIGS. 5 and 6 below, a detailed description will be given of a process in which a water surface sensor module and an underwater sensor module according to an embodiment of the present disclosure sense one or more swimmer body parts located above and below the water surface.

First, referring to FIG. 5, the plurality of water sensors 111 to 116 provided in the water surface sensor module 110 according to an embodiment of the present disclosure may sense one or more swimmer body parts protruding above the water surface. Specifically, the first water surface sensor 111 may sense a head part among body parts of a first swimmer 21, and the second water surface sensor 112 may sense a left arm part and a head part Next, the plurality of water surface sensors 111 to 116 may detect an echo signal reflected from the one or more sensed swimmer body parts.

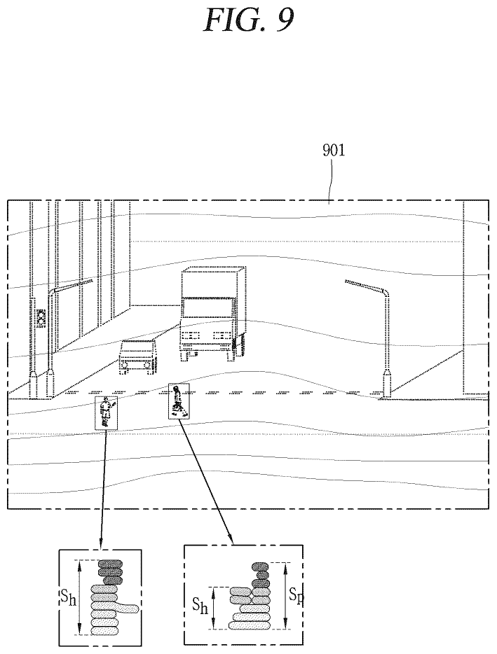

Next, the water surface sensor module 110 may collect one or more echo signals detected by the plurality of water surface sensors 111 to 116 to acquire first information on swimmer body parts including coordinate information (x, y) at which each of the sensed swimmer body parts is located, distance information from the water surface to the sensed body part, and body part identification information that identifies the sensed body part. The body part identification information may be predefined as a head part, a right arm part, a left arm part, or the like, but is not limited thereto. A specific method of acquiring first information on a swimmer body part by the foregoing water surface sensor module 110 will be described in detail in FIG. 9.

Next, referring to FIG. 6, a plurality of underwater sensors 121 to 126 provided in the underwater sensor module 120 according to an embodiment of the present disclosure may sense one or more swimmer body parts located below the water surface. Specifically, the first underwater sensor 121 may sense a head part, a left arm part, and a left leg part among body parts of a third swimmer 23, and the third underwater sensor 123 may sense right leg and left leg parts among body parts of a fourth swimmer 24.

Next, the plurality of underwater sensors 121 to 126 may detect an echo signal reflected from the one or more sensed swimmer body parts.

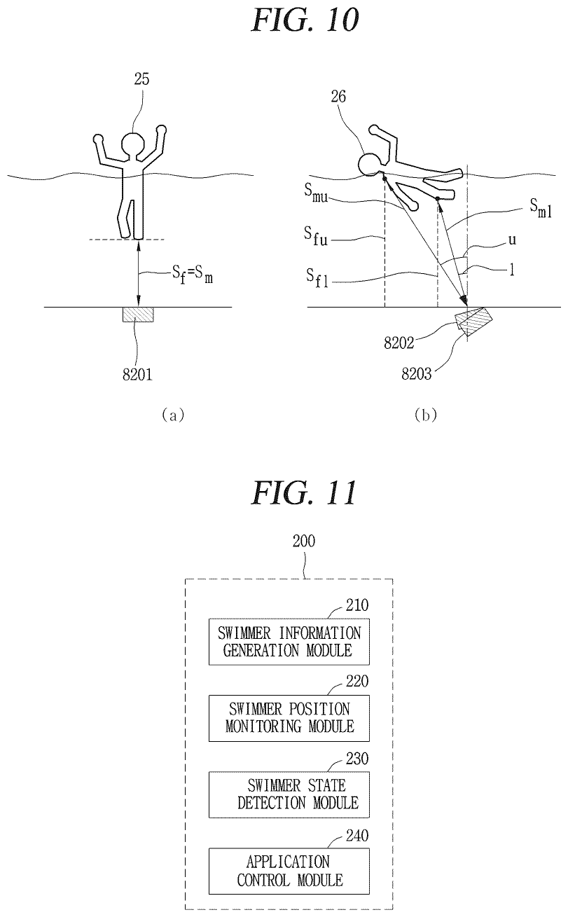

Next, the underwater sensor module 120 may collect one or more echo signals detected by the plurality of underwater sensors 121 to 126 to acquire second information on swimmer body parts including coordinate information (x, y) at which each of the sensed swimmer body parts is located, and distance information from a bottom surface of the swimming pool to the sensed body part. A specific method of acquiring second information on a swimmer body part by the foregoing underwater sensor module 120 will be described in detail in FIG. 10.

Meanwhile, the plurality of sensors provided in the water surface sensor module 110 according to an embodiment of the present disclosure may be light detection and ranging (LiDAR) sensors or radio detection and ranging (RADAR) sensors, but are not limited thereto. In general, the lidar sensor may denote a sensor that detects an object by emitting a laser beam and sensing an echo signal that is reflected back. Additionally, the radar sensor may denote a sensor that detects an object by emitting electromagnetic waves and sensing the electromagnetic waves that are reflected back.

In general, the lidar sensor or radar sensor has a relatively low data resolution and low sampling rate compared to a camera, but therefore has an advantage of low privacy issues because it is difficult to distinguish a specific person. In addition, it has an advantage of being able to detect multiple objects simultaneously, having a relatively long detection area compared to a camera, and being relatively less affected by bad external weather and lighting environments.

Meanwhile, the plurality of sensors provided in the underwater sensor module 120 according to an embodiment of the present disclosure may be optical sensors or ultrasonic sensors, but are not limited thereto. Additionally, the optical sensor may include a light detection and ranging (LiDAR) sensor or a time-of-flight (ToF) infrared proximity sensor, but is not limited thereto.

In general, the ToF infrared proximity sensor may denote a sensor that detects an object by using a phase change due to a period of time it takes for an infrared signal to travel back and forth to the object after emitting an infrared signal modulated with a signal of a specific frequency from a transmitter of the sensor and sensing the infrared signal reflected back from the object from a receiver of the sensor. In general, an optical sensor has an advantage of being easy to maintain because it can be located at a bottom portion of a medium with a high optical transmittance, such as acrylic.

Meanwhile, in general, an ultrasonic sensor may denote a sensor that detects an object by using a time difference between a sound transmitted from the transmitter and an echo sound reflected back. In general, the ultrasonic sensor has an advantage of high object recognition rate because it is not affected by environmental factors such as external lighting, and capable of detecting a wide range of objects because it has a large field of view (FoV).

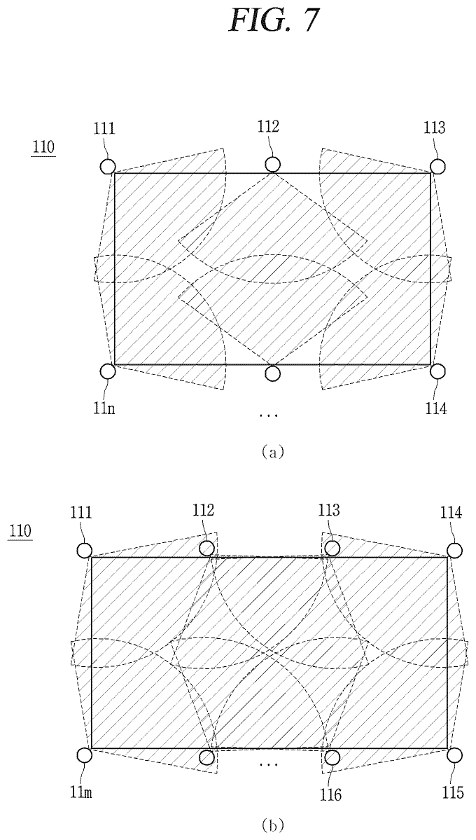

Referring to (a) and (b) of FIG. 7 below, an embodiment in which a plurality of water surface sensors are arranged in the water surface sensor module 110 according to an embodiment of the present disclosure will be described in detail.

(a) and (b) of FIG. 7 are cross-sectional views showing the water surface sensor module 110 in FIG. 3 from above. Referring to (a) and (b) of FIG. 7, a number and arrangement method of a plurality of water surface sensors provided in the water surface sensor module 110 may be determined based on a size of the swimming pool and a sensing range of the water surface sensors.

First, according to a method of arranging the water surface sensor module 110 shown in (a) of FIG. 7, a blind spot may occur outside a sensing range sensed by first and n-th water surface sensors 111 to 11n. In this regard, the blind spot denotes an area not covered by the first to n-th sensing ranges sensed by the first and n-th water surface sensors 111 to 11n.

Meanwhile, according to a method of arranging the water surface sensor module 110 shown in (b) of FIG. 7, it may be arranged not to allow a blind spot to occur within a range sensed by first and m-th water surface sensors 111 to 11m. Referring to (b) of FIG. 7, as a predetermined number or more of water surface sensors are arranged in a vertical direction, an entire detection target area by the first and m-th water surface sensors 111 to 11m may be covered by at least one of a first sensing range by the first water surface sensor 111 to an m-th sensing range by the m-th water surface sensor 11m. In this regard, a number m of water surface sensors in (b) of FIG. 7 may be determined to be larger than a number n of water surface sensors in (a) of FIG. 7.

Referring to FIGS. 8A to 8C below, an embodiment in which a plurality of underwater sensors are arranged in an underwater sensor module according to an embodiment of the present disclosure will be described in detail.

FIGS. 8A to 8C are cross-sectional views showing the underwater sensor module 120 in FIG. 2 from above. Referring to FIG. 8A, a number and arrangement method of a plurality of underwater sensors provided in the underwater sensor module 120 may be determined based on a bezel spacing D1, D2 of a display 820 disposed on a bottom surface of the swimming pool and a sensing range of the underwater sensors.

Hereinafter, various embodiments in which a plurality of underwater sensors are arranged will be described in detail with reference to FIG. 8A. First, in order not to cover a plurality of display panels 821 to 829 included in the display 820, the plurality of underwater sensors according to an embodiment of the present disclosure are preferably arranged in parallel to form a plurality of rows and columns in a horizontal direction or vertical direction between the display panels 821 to 829, but are not limited thereto.

(a) of FIG. 8A shows an embodiment in which a plurality of underwater sensors are arranged in parallel between a plurality of display panels 821 to 829 to form grid-like lines inside the display 820. In addition, (d) of FIG. 8A, which is a conceptual diagram partially expanding area A shown in (a) of FIG. 8A, specifically shows an embodiment in which a plurality of underwater sensors 8201 to 8205 are arranged in parallel to form a line in a vertical direction between the display panels 821, 822.

Meanwhile, when the display 300 according to an embodiment of the present disclosure aims to be bezel-less, as shown in (b) and (c) of FIG. 8A, it may be arranged in parallel to form one or more lines in a horizontal direction or vertical direction or may be arranged only in a partial area of a line, but is not limited thereto.

Referring to FIGS. 8B to 8C below, a method of arranging an underwater sensor module in consideration of a sensing range of the underwater sensor will be described in detail.

(a) of FIG. 8B shows an embodiment in which a plurality of underwater sensors according to an embodiment of the present disclosure are arranged in parallel to form one or more lines in a vertical direction between display panels 821 to 829.

In addition, (b) of FIG. 8B is a conceptual diagram partially expanding area B shown in (a) of FIG. 8B, and (c) of FIG. 8B is a conceptual diagram showing a sensing range of the first and third underwater sensors 8201 to 8203 shown in (b) of FIG. 8B.

In addition, (d) of FIG. 8B, which is a conceptual diagram showing the first and third underwater sensors 8201 to 8203 in (c) of FIG. 8B from the front, shows an entire detection target area 8300 by the first and third underwater sensors 8201 to 8203 and a sensing range 8400 sensed by the first and third underwater sensors 8201 to 8203.

Referring again to (c) of FIG. 8B, a field of view (FoV) of the first to third underwater sensors 8201 to 8203 provided in the underwater sensor module 120 may be defined as σ. In this case, when the first to third underwater sensors 8201 to 8203 are all arranged in a vertical direction with respect to the display panel, a blind spot may occur outside a sensing range sensed by the first to third underwater sensors 8201 to 8203 as shown in (d) of FIG. 8B. In this regard, the blind spot denotes an area that is not covered by a sensing range sensed by the first and third underwater sensors 8201 to 8203 in the entire detection target area 8300 by the first to third underwater sensors 8201 to 8203 below the water surface.

Meanwhile, according to the arrangement method of the underwater sensor module 120 shown in FIG. 8C, it may be arranged not to allow a blind spot to occur within a sensing range sensed by the first and third underwater sensors 8201 to 8203 below the water surface.

(a) of FIG. 8C shows an embodiment in which a plurality of underwater sensors according to an embodiment of the present disclosure are arranged in parallel to form one or more lines in a vertical direction between display panels 821 to 829.

In addition, (b) of FIG. 8C is a conceptual diagram partially expanding area C shown in (a) of FIG. 8C, and (c) of FIG. 8C is a conceptual diagram showing an embodiment in which at least one of the first and third underwater sensors 8201 to 8203 shown in (b) of FIG. 8C is arranged to be inclined at a predefined inclination angle with respect to a vertical direction of the display panel.

In addition, (d) of FIG. 8C, which is a conceptual diagram showing the first and third underwater sensors 8201 to 8203 in (c) of FIG. 8C from the front, shows an entire detection target area 8300 by the first and third underwater sensors 8201 to 8203 and a sensing range 8400 sensed by the first and third underwater sensors 8201 to 8203.

Referring again to (c) of FIG. 8C, a field of view (FoV) of the plurality of underwater sensors 8201 to 8203 may be defined as o. In this case, among the plurality of underwater sensors 8201 to 8203, the first underwater sensor 8201 may be arranged in a vertical direction of the display panel, the second underwater sensor 8202 may be arranged to be inclined at a first inclination angle (θ) from the vertical direction of the display panel, and the third underwater sensor 8203 may be arranged to be inclined at a second inclination angle (Φ) from the vertical direction of the display panel. In this case, as shown in (d) of FIG. 8C, the entire detection target area 8300 may be covered by at least one of the first to third sensing ranges by the first to third underwater sensors 8201 to 8203.

For convenience of explanation below, the first underwater sensor arranged in the vertical direction of the display panel is referred to as a ‘vertical measurement underwater sensor 8201’, the second underwater sensor arranged to be inclined at a first inclination angle (θ) from the vertical direction of the display panel and spaced apart from the vertical measurement underwater sensor is referred to as a ‘first inclination measurement underwater sensor 8202’, and the third underwater sensor arranged to be inclined at a second inclination angle (Φ) from the vertical direction of the display panel and spaced apart from the second inclination measurement underwater sensor is referred to as a 'second inclination measurement underwater sensor 8203′.

Meanwhile, when a range of inclination angles of the inclination measurement underwater sensors arranged at an inclination angle with respect to the vertical direction of the display panel, such as the foregoing first and second inclination measurement underwater sensors 8202 and 8203, is configured to be more diverse, the foregoing blind spot may be further reduced. Taking this into consideration, the method of arranging the underwater sensor module 120 according to an embodiment of the present disclosure may be determined, but is not limited thereto.

Referring to FIG. 9 below, a specific method of acquiring first information on a swimmer body part by a water surface sensor module according to an embodiment of the present disclosure will be described.

A water surface sensor module according to an embodiment of the present disclosure may collect one or more echo signals reflected from the one or more sensed swimmer body parts to extract coordinate information (x, y) of the sensed body part and an image 901 including the sensed body part. Here, the coordinate information (x, y) of the sensed body part may be information indicating where the body part is located within the pool. Meanwhile, the image 901 shown in FIG. 9 may illustrate an image extracted by a plurality of lidar sensors provided in a water surface sensor module according to an embodiment of the present disclosure.

Next, the sensed body part may be identified to determine which body part of a swimmer it is based on the extracted image 901, thereby acquiring body part identification information. The body part identification information may be predefined as, for example, a head part, a chest part, a right arm part, or a right leg part, but is not limited thereto.

Meanwhile, when one of the identified body parts is determined to be a swimmer's head part, a distance from the water surface to a head part of the swimmer may be acquired. Hereinafter, for convenience of explanation, the extracted distance is referred to as a ‘swimmer head height (Sh)’. Additionally, when another body part is identified at a higher position than the swimmer's head part among the identified body parts, a distance from the water surface to the body part at the highest position may be acquired. Hereinafter, for convenience of explanation, the extracted distance is referred to as a ‘swimmer peak height (Sp)’. The swimmer head height (Sh) and the swimmer peak height (Sp) may be included in distance information from the water surface to the sensed body part, but is not limited thereto.

Meanwhile, one or more echo signals reflected from the one or more sensed swimmer body parts may be converted into a spectrum image to extract the position of the swimmer body part and an image including the swimmer body part. The position of the swimmer body part and the image including the swimmer body part may be extracted through preprocessing of a surrounding noise and spectral image conversion for echo signals from a plurality of directions, but is not limited thereto. In this regard, when different types of chirp signals are emitted spatially, an echo signal reflecting object characteristic information in space may be received.

Referring to FIG. 10 below, a specific method of acquiring first information on a swimmer body part by an underwater sensor module according to an embodiment of the present disclosure will be described.

An underwater sensor module according to an embodiment of the present disclosure may collect one or more echo signals reflected from the one or more sensed swimmer body parts to acquire coordinate information (x, y) of the sensed body parts and distance information from a bottom surface of the swimming pool.

Referring to (a) of FIG. 10, the vertical measurement underwater sensor 8201 may sense a right leg part of a fifth swimmer 25. In this case, a distance (Sf) between the bottom surface of the swimming pool and a right leg part of the fifth swimmer 25 may be calculated as a distance (Sm) to the right leg part of the fifth swimmer 25 measured by the vertical measurement underwater sensor 8201.

Meanwhile, the first inclination measurement underwater sensor 8202 shown in (b) of FIG. 10 may sense a left leg part of a sixth swimmer 26, and the second inclination measurement underwater sensor 8203 may sense a left shoulder part of the sixth swimmer 26. In this case, a distance (Sfl) between the bottom surface of the swimming pool and a left leg part of the sixth swimmer 26 may be calculated as in [Equation 1] using a distance (Sml) to the left leg part of the sixth swimmer 26 measured by the first inclination measuring underwater sensor 8202 and a first inclination angle (/) of the first inclination measurement underwater sensor 8202.

S_{fl}=Sₘₗ×cos l [Equation 1]

In addition, a distance (Sfu) between the bottom surface of the swimming pool and a left shoulder part of the sixth swimmer 26 may be calculated as in [Equation 2] using a distance (Smu) to the left shoulder part of the sixth swimmer 26 measured by the second inclination measurement underwater sensor 8203 and a second inclination angle (u) of the second inclination measurement underwater sensor 8203.

S_{fu}=Sₘᵤ×cos u [Equation 2]

Hereinafter, FIGS. 11 to 17 specifically describe in detail the processor 200 among the elements of the interaction swimming pool system according to an embodiment of the present disclosure.

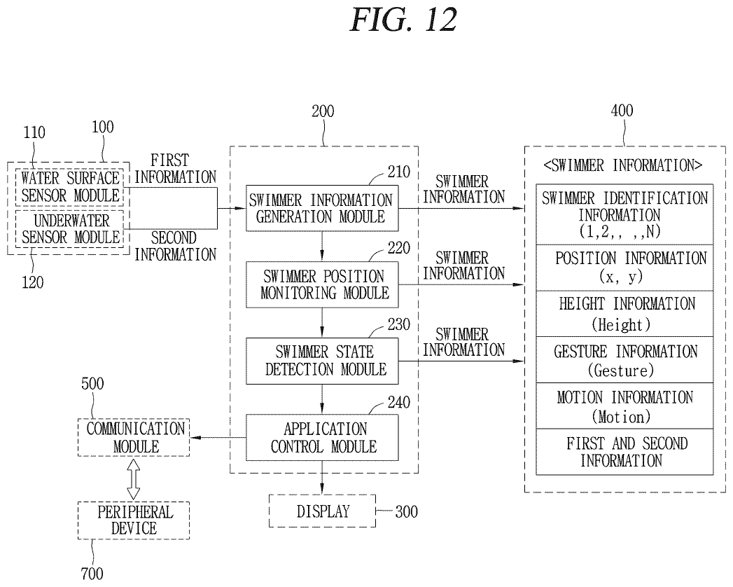

FIG. 11 is an internal block diagram of the processor 200 according to an embodiment of the present disclosure, and FIG. 12 is a configuration diagram showing a process in which the processor 200 interacts with a water surface sensor module 110, an underwater sensor module 120, a display 300, and a memory 400.

First, referring to FIG. 11, the processor 200 according to an embodiment of the present disclosure may include a swimmer information generation module 210, a swimmer position monitoring module 220, a swimmer state detection module 230, and an application control module 240, but is not limited thereto. module 210 according to an embodiment of the present disclosure fuses first and second information on a swimmer body part received from the water surface sensor module 110 and the underwater sensor module 120 to generate swimmer information on a swimmer including the swimmer's body part, and may store the generated swimmer information in the memory 400 operatively coupled to the processor 200.

The swimmer information stored in the memory 400 may include one or more of swimmer identification information (1, 2, . . . , N) that identifies the swimmer, swimmer position information, height information, gesture information, and motion information, but is not limited thereto. In addition, the swimmer information may further include first and second information on swimmer body parts input from the water surface sensor module 110 and the underwater sensor module 120, but is not limited thereto.

For convenience of explanation below, an algorithm of generating swimmer information on the swimmer by fusing the first and second information input according to an embodiment of the present disclosure is referred to as a ‘swimming sensor fusion algorithm.’

Referring again to FIG. 12, the swimmer position monitoring module 220 according to an embodiment of the present disclosure may monitor the position (x, y) of one or more swimmers located within the pool by referring to one or more swimmer information generated by the swimmer information generation module 210, and may update the position information (x, y) of the swimmer information stored in the memory 400 based on the monitoring result.

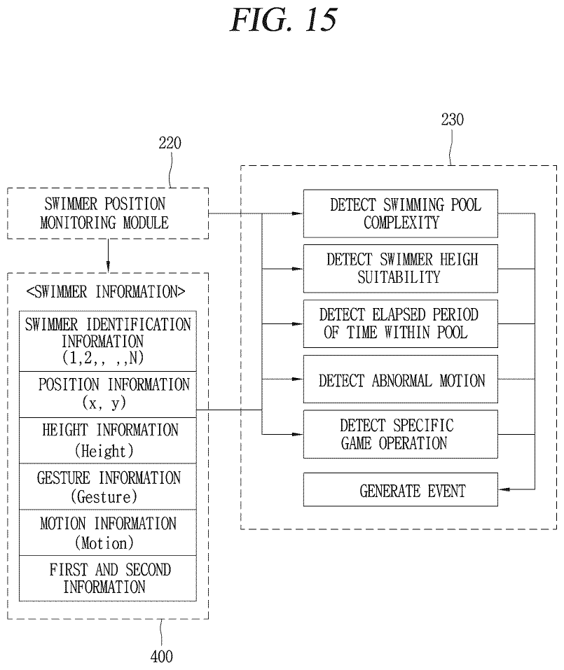

Next, the swimmer state detection module 230 according to an embodiment of the present disclosure may detect the state of one or more swimmers based on a result of the monitoring by the swimmer position monitoring module 220 and the swimming pool information stored in the memory 400, and generate one or more preset events corresponding to a result of the detection. A specific method of detecting, by the foregoing swimmer state detection module 230, the swimmer's state will be described in detail in FIG. 15.

Next, the application control module 240 included in the processor 200 according to an embodiment of the present disclosure may detect the generated event to control an application corresponding to the event to be executed, and also control an execution screen of the application to be output to the display 300.

In addition, the application control module 240 according to an embodiment of the present disclosure may detect the generated event to control notification information included in the event to be transmitted to a peripheral device 700 through the communication module 500, but is not limited thereto.

Hereinafter, a method of calculating, by the swimmer generation module 210 according to an embodiment of the present disclosure, swimmer information on a swimmer through a swimming sensor fusion algorithm will be described in detail.

First, the swimmer information generation module 210 may generate swimmer identification information (1, 2, . . . , N) that can be uniquely assigned to each swimmer in order to identify the swimmer including the sensed body part. among one or more objects sensed by the underwater sensor module 120 arranged below the water surface, an object other than a body part of the swimmer may be included. In this case, a deep learning-based overlapping detection algorithm may be applied to distinguish an object that is not part of the swimmer's body from the swimmer body part. The deep learning-based overlapping detection algorithm may be performed by using coordinate information (x, y), gesture information, a swimmer head height, and a swimmer peak height of one or more objects sensed by the water surface sensor module 110 and the underwater sensor module 120, but is not limited thereto.

Next, the swimmer information generation module 210 may receive coordinate information (x, y) of a body part sensed above the water surface and coordinate information (x, y) of a body part sensed below the water surface to generate position information (x, y) of the identified swimmer through a swimming sensor fusion algorithm.

Next, the swimmer information generation module 210 may generate height information of the identified swimmer by receiving the swimmer head height acquired by the water surface sensor module 110 and distance information and coordinate information (x, y) from the water surface to the sensed body part acquired by the underwater sensor module 120.

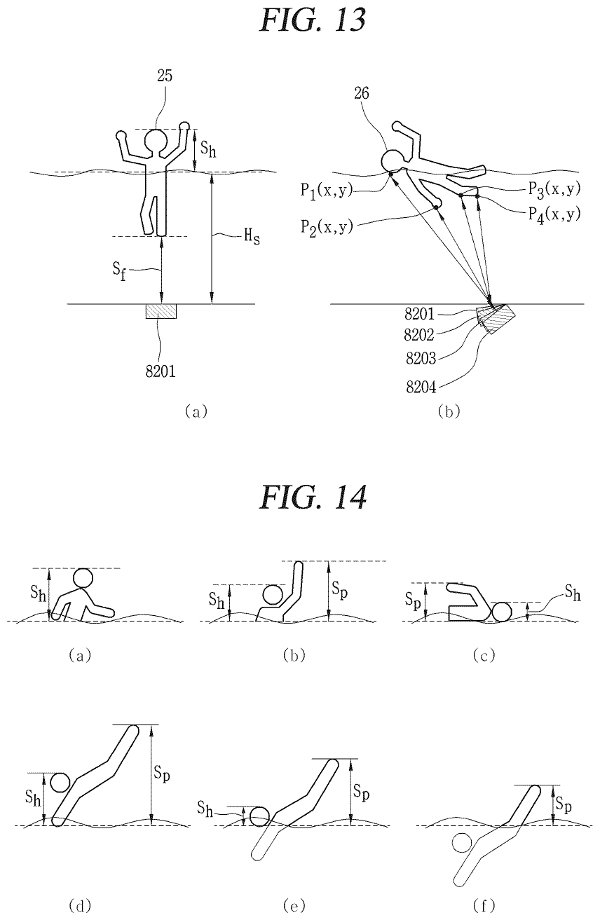

Hereinafter, referring to (a) and (b) of FIG. 13, a method of generating height information of a swimmer through a swimming sensor fusion algorithm according to an embodiment of the present disclosure will be specifically described, but is not limited thereto.

First, referring to (a) of FIG. 13, the swimmer's height information (Sheight) may be calculated as in [Equation 3] below using the swimmer head height (Sh) acquired from the water surface sensor module 110, a height (Hs) from the bottom surface of the swimming pool to the water surface, and a distance (Sf) from the bottom surface of the swimming pool to the swimmer body part acquired from the first underwater sensor 8201.

S_{height}=Sₕ+(Hₛ−S_{f}) [Equation 3]

Next, referring to (b) of FIG. 13, two coordinates located at the farthest distance among coordinate information (P1(x, y) to P4(x, y)) of the first to fourth swimmer body parts acquired from the underwater sensor module 120 provided with the first to fourth underwater sensors 8201 to 8204 may be extracted to calculate the swimmer's height information (Sheight) including the swimmer body parts as in [Equation 4].

S_{height}=max(betweenP_{N}(x,y)) [Equation 4]

Next, referring to (a) to (f) of FIG. 14, a method of generating gesture information of the swimmer through a swimming sensor fusion algorithm according to an embodiment of the present disclosure will be described with various examples, but is not limited thereto.

Referring to (a) to (f) of FIG. 14, using the swimmer head height (Sh) and the swimmer peak height (Sp), and one or more body part identification information acquired from the water surface sensor module 110, the swimmer's gesture may be inferred to generate gesture information.

First, referring to (a) and (b) of FIG. 14, when one or more swimmer body parts corresponding to an upper body part of the swimmer are sensed, and the swimmer head height (Sh) and the swimmer peak height (Sp) are both above the swimmer upper body length, which can be calculated in proportion to the swimmer height, it may be determined that the swimmer's upper body is exposed above the water surface. In this case, as shown in (b) of FIG. 14, when the swimmer peak height (Sp) is higher than the swimmer head height (Sh), and a body part corresponding to the swimmer peak height (Sp) is determined to be an arm part, it may be inferred that the swimmer is in a position where he or she is raising his or her arm above the water surface.

Meanwhile, the swimmer upper body length, which can be calculated in proportion to the swimmer height information, may be calculated in a range of ⅓ to ½ of the swimmer height, but is not limited thereto.

Next, referring to (c) of FIG. 14, when head and arm parts of the swimmer are sensed, the swimmer head height (Sh) is below the swimmer upper body length, which can be calculated in proportion to the swimmer height, and the swimmer peak height (Sp) is determined to be an arm part, it may be inferred that the swimmer is lying on the water surface with his arm raised.

Next, as shown in (d) to (f) of FIG. 14, a body part corresponding to the swimmer peak height (Sp) of the swimmer is determined to be a leg part, it may be determined that the swimmer is in a diving position entering the water upside down. In this case, in the case of (d) of FIG. 14, it may be inferred that the swimmer has not yet entered the water based on the detection of all body parts of the swimmer, in the case of (e) of FIG. 14, it may be inferred that the swimmer is entering the water based on the detection of some body parts of the swimmer, and in the case of (f) of FIG. 14, it may be inferred that the swimmer is in a diving position with an entire upper body below the water surface based on that the swimmer head height (Sh) is 0, but is not limited thereto.

Next, the swimmer information generation module 210 according to an embodiment of the present disclosure may receive first and second information on a swimmer body part to generate motion information including a motion pattern of the identified swimmer through a swimming sensor fusion algorithm.

Hereinafter, motion patterns of a swimmer according to various embodiments of the present disclosure will be described in detail, but are not limited thereto.

The foregoing motion patterns of the swimmer may include (1) a motion speed of the swimmer, (2) up-down and left-right motion patterns of the swimmer, (3) up-down and left-right motion patterns in specific body parts of the swimmer, and (4) motion patterns of the swimmer head height and swimmer peak height, but are not limited thereto.

Specifically, the motion speed of the swimmer may be calculated based on a change in the swimmer's position information (x, y) included in the swimmer information.

In addition, an up-and-down motion pattern of the swimmer may be calculated based on a change in distance information from the bottom surface of the swimming pool acquired by the underwater sensor module 120, and a left-right motion pattern of the swimmer may be calculated based on a change in an x value of the coordinate information (x, y) of a body part acquired by the underwater sensor module 120.

In addition, the up-down and left-right motion patterns of a specific body part exposed above the water surface may be calculated based on a change in body part identification information and body part coordinate information (x, y) acquired by the water surface sensor module 110, and the up-down and left-right motion patterns of a specific body part located below the water surface may be calculated based on a change in coordinate information (x, y) of one or more swimmer body parts sensed within a specific area of the swimming pool acquired by the underwater sensor module 120, but are not limited thereto.

Additionally, a motion pattern of the swimmer head height may be calculated based on a change in the swimmer head height acquired by the water surface sensor module 110, and a motion pattern of the swimmer peak height may be calculated based on a change in the swimmer peak height and body part identification information acquired by the water surface sensor module 110, but are not limited thereto.

The foregoing generation of motion pattern information of the swimmer may be learned and generated using a generally known deep learning-based image processing algorithm, but is not limited thereto.

Meanwhile, the motion pattern information of the swimmer may be information used to detect whether the swimmer intentionally moves in a specific motion pattern or whether the swimmer unintentionally moves in an abnormal motion pattern, but is not limited thereto.

Referring again to FIG. 12, the swimmer position monitoring module 220 according to an embodiment of the present disclosure may monitor the position of a swimmer located within the pool based on swimmer information generated by the foregoing swimmer information generation module 210.

Specifically, the swimmer's current position (x, y) included in the swimming pool information may be compared with the swimmer's previous position (x, y) stored in the memory 400 to detect whether the position of the swimmer within the pool has changed. Additionally, based on a result of the detection, the swimmer's position information stored in the memory 400 may be updated to the swimmer's current position (x, y) to monitor the swimmer's position.

Referring again to FIG. 12, the swimmer state detection module 230 according to an embodiment of the present disclosure may detect the state of one or more swimmers by referring to a result of the swimmer position monitoring and swimmer information stored in the memory 400.

Referring to FIG. 15 below, a process of detecting, by the swimmer state detection module 230 according to an embodiment of the present disclosure, a swimmer's state, and generating a preset event based on a result of the detection will be described in detail.

First, the swimmer state detection module 230 may count a number of swimmers within the pool based on a result of the foregoing swimmer position monitoring and the swimmer information stored in the memory 400.

In this case, when a number of swimmers located within the pool changes, a complexity of the swimming pool may be calculated as ‘HIGH’, ‘MIDDLE’, or ‘LOW’ based on the number of swimmers and a predefined swimming pool capacity range. Additionally, when the number of swimmers located within the pool is undetectable, a complexity of the swimming pool may be further calculated as ‘VERY HIGH’, but is not limited thereto.

Next, based on a result of the classification, notification information including the swimmer's position information and the swimming pool complexity may be generated to generate a predefined event.

Next, the swimmer state detection module 230 may detect whether one or more swimmers are located in a specific area of a swimming pool with a depth suitable for the swimmer's height based on a result of the foregoing swimmer position monitoring and the swimmer information stored in the memory 400.

Next, based on a result of the detection, it is determined that the swimmer is in a dangerous state, and notification information including the swimmer's identification information, position information, and a warning guidance message may be generated to generate a predefined event.

Next, the swimmer state detection module 230 may detect a period of time that one or more swimmers stay within the pool based on a result of the foregoing swimmer position monitoring and the swimmer information stored in the memory 400.

Next, when the detected period of time exceeds a predefined suitable swimming period of time range, the swimmer may be determined to need a rest, and notification information including the swimmer's identification information, position information, and a rest guidance message may be generated to generate a predefined event.

Next, the swimmer state detection module 230 may refer to a result of the foregoing swimmer position monitoring and the swimmer information stored in the memory 400 to determine whether motion pattern information of the swimmer included in the swimmer information matches a predefined

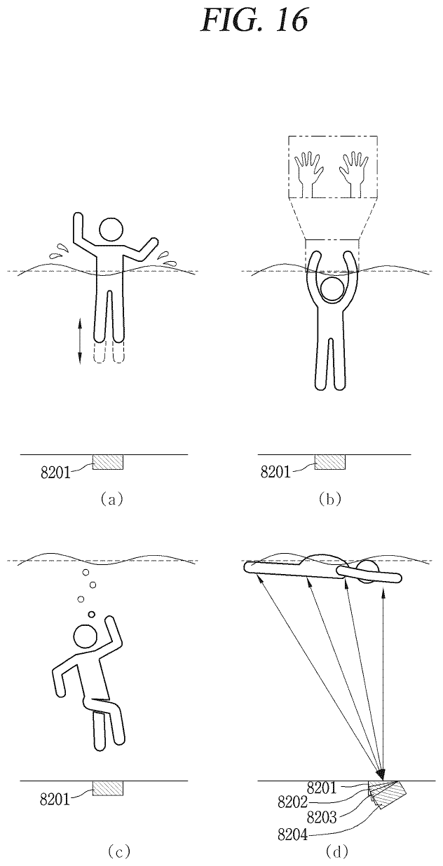

In one embodiment, (a) of FIG. 16 shows an abnormal state in which a swimmer is floundering in the pool. The swimmer's motion pattern shown in (a) of FIG. 16 below is referred to as a ‘floundering motion pattern’.

In this case, there may be more up-down motions than left-right motions in general. In order to detect this, it may be possible to determine that the swimmer performs a ‘floundering motion pattern’ by detecting whether the swimmer's up-and-down motion pattern included in the swimmer's motion information matches an up-and-down motion pattern included in a predefined ‘swimmer floundering motion pattern’ and whether the up-and-down motion pattern is repeated above a preset number of times over a preset period of time.

Additionally, when the swimmer repeats a ‘floundering motion pattern’, the swimmer's arm part may be repeatedly exposed above the water surface or the arm part may move repeatedly in an up-and-down direction. In order to detect this, it may be possible to determine that the swimmer performs a ‘floundering motion pattern’ by detecting whether an up-and-down motion pattern of an arm part exposed above the water surface included in the swimmer's motion information matches an up-and-down motion pattern of an arm part included in a predefined ‘swimmer floundering operation pattern’ and whether an up-and-down motion pattern of the arm part is repeated above a preset number of times over a preset period of time.

In one embodiment, (b) of FIG. 16 shows an abnormal state in which a swimmer's head part is gradually submerged or repeatedly submerged in the pool. The swimmer's motion pattern shown in (b) of FIG. 16 below is referred to as a ‘head immersion motion pattern’.

In this case, in general, the swimmer head part may repeat an operation of being located below the water surface or protruding a predetermined length above the water surface, and the swimmer's hand part may repeat an operation of protruding above the water surface.

In order to detect this, it may be possible to determine that the swimmer performs a ‘head immersion motion pattern’ by detecting whether the swimmer head height included in the swimmer motion pattern information remains at 0 over a predetermined period of time in the ‘head immersion operation pattern’ or repeatedly changes within a predetermined length range. In addition, it may be possible to determine that the swimmer exhibits a ‘head immersion motion pattern’ by detecting whether an up-and-down motion pattern of a specific body part included in the swimmer motion pattern information and a swimmer peak height predefined in the ‘head immersion motion pattern’repeatedly fluctuate within a predefined length range.

In one embodiment, (c) of FIG. 16 shows an abnormal state in which the swimmer's head part sinks under the pool. An embodiment of a swimmer's motion pattern repeating a ‘full body immersion motion pattern’ is shown in (c) of FIG. 16 below.

In this case, when the swimmer head height and the swimmer peak height remain at 0 over a predetermined period of time in the ‘head immersion motion pattern’, and the swimmer's up-and-down or left-right motion pattern below the water surface included in the swimmer motion pattern information gradually decreases, it may be determined that the swimmer performs a 'full body immersion motion pattern'.

In one embodiment, (d) of FIG. 16 shows a swimmer exhibiting a state of drowning in progress. The swimmer's motion pattern shown in (d) of FIG. 16 below is referred to as a ‘drowning state motion pattern’.

In this case, in general, the swimmer may be in a floating position motionless above the water surface, with a back of a head, part of a back, or part of a leg of the swimmer protruding above the water surface.

In order to detect this, when there is almost no swimmer motion speed included in the swimmer motion information, and the swimmer body part sensed above the water surface based on the body part identification information included in the swimmer motion information is a back part of a head, a back part, or a leg part of the swimmer, it may be determined that the swimmer performs a ‘drowning state motion pattern’. Additionally, even when the swimmer head height and the swimmer peak height remain within a predetermined range predefined in the ‘head submersion motion pattern’, the swimmer may be determined to be in a ‘drowning state motion’.

The swimmer state detection module 230 according to an embodiment of the present disclosure may generate, when the foregoing abnormal motion pattern of the swimmer is detected, notification information including the swimmer's identification information, position information, and a risk guidance message to generate a predefined event.

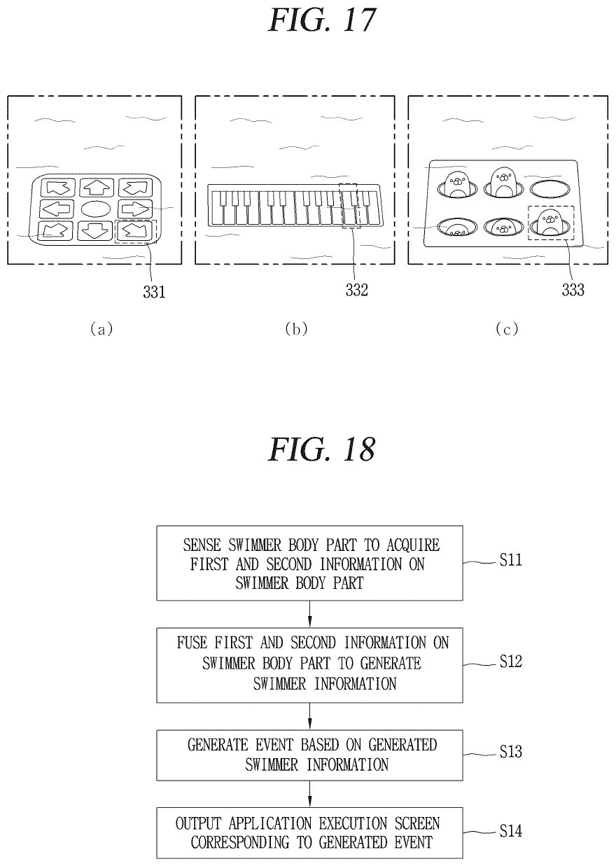

Meanwhile, the swimmer state detection module 230 may determine whether the swimmer's motion pattern information included in the swimmer information matches an operation pattern predefined in a plurality of game applications installed in the swimming pool system based on a result of the foregoing swimmer position monitoring and the swimmer information stored in the memory 400. applications according to an embodiment of the present disclosure. (a) of FIG. 17 is an exemplary diagram showing an Aqua DDR game according to an embodiment, and (b) of FIG. 17 is an exemplary diagram illustrating an Aqua Piano game. In addition, (c) of FIG. 17 is an exemplary diagram showing Aqua Mole (mole game).

The swimmer state detection module 230 according to an embodiment of the present disclosure may determine whether the swimmer's motion pattern information included in the swimmer information matches a predefined motion pattern in a specific game application when one or more predefined game applications are activated.

Predefined motion patterns in the specific game application may include Stand, Jump, Waving L/R Hand, Region Pressing by foot, and the like, but are not limited thereto. The Stand pattern denotes that the swimmer is detected to be in a standing state in part 331 to 333 of an area where the game screen is displayed, such as in (a) to (c) of FIG. 17. The Jump pattern denotes that the swimmer is detected to be in a jumping state in part 331 to 333 of an area where the game screen is displayed. The Waving L/R Hand pattern denotes that the swimmer is detected to be in a state of waving either his left or right hand. Region Pressing by foot denotes that the swimmer is detected to be in a state of pressing a specific area where the game screen is displayed by his or her foot.

The swimmer state detection module 230 according to an embodiment of the present disclosure may generate, when one or more of the foregoing game application motion patterns are detected, notification information including the swimmer's identification information and position information and the game application motion pattern information to generate a preset event.

Referring again to (a) of FIG. 17, an embodiment in which an application execution screen is output to the display 300 included in the interaction swimming pool system 10 according to an embodiment of the present disclosure will be described in detail.

The display 300 included in the swimming pool system 10 according to an embodiment of the present disclosure may be provided with one or more displays, at least one of the one or more displays may be disposed in a form of a rooftop signage display, and at least another one may be disposed on a bottom surface of a swimming pool in a form of a flow signage display.

Additionally, the application execution screen may be output to one or more of the foregoing displays, but is not limited thereto.

First, according to an embodiment of the present disclosure, when one or more swimmer body parts are sensed in an area where one or more game application execution screens are displayed, the processor may output an initial screen of a launcher application that executes the game application to the display.

Next, when a game-related motion pattern used in a game application is detected by the swimmer state detection module, the application control module may execute a corresponding application based on the detected game-related motion pattern. Additionally, the application control module may control the executed application game screen to be output to the display. application by determining whether the motion information included in the swimmer information matches a motion pattern related to the executed application, such as Stand, Jump, Waving L/R Hand, Region Pressing by foot, and the like. Additionally, based thereon, a newly generated application game screen may be controlled to be output to the display.

For example, an embodiment of executing an Aqua DDR application in (a) of FIG. 17 may be considered. First, when a swimmer body part is sensed in an area where an Aqua DDR execution screen is displayed, an initial screen of a launcher application that runs an Aqua DDR application may be output to the display. Then, the swimmer state detection module may determine whether the motion information included in the swimmer information matches a Jump operation used in the Aqua DDR application. Additionally, a newly generated Aqua DDR application execution screen may be controlled to be output to the display based on a result of the determination, but is not limited thereto.

Hereinafter, a control method of the interaction swimming pool system 10 according to an embodiment of the present disclosure will be described in detail.

Referring to FIG. 18, the control method of the interaction swimming pool system 10 according to an embodiment of the present disclosure may include acquiring first and second information (S11), generating information on a swimmer (S12), generating an event (S13), and controlling the generated event to be output to a display (S14).

In the acquiring of first and second information (S11), a swimmer body part may be sensed through a first sensor module above a water surface and a second sensor module below the water surface to acquire the first and second information on the swimmer body part.

The first sensor module above the water surface may include a plurality of water surface sensors above the water surface, to detect one or more echo signals reflected from one or more swimmer body parts protruding above the water surface. In addition, the one or more detected echo signals may be collected to acquire first information on the swimmer body part including coordinate information (x, y) at which each sensed swimmer body part is located, distance information from the water surface to the sensed body part, and body part identification information that identifies the sensed body part.

Meanwhile, the second sensor module below the water surface may include a plurality of underwater sensors below the water surface to detect one or more echo signals reflected from the swimmer body part located below the water surface. Additionally, the one or more detected echo signals may be collected to acquire coordinate information (x, y) of the sensed body part and distance information from a bottom surface of the swimming pool.

Next, in the generating of information of a swimmer (S12), the first and second information input from the first and second sensor modules may be fused to generate the swimmer's position, height, gesture, and motion information and swimmer identification information (1, 2, . . . , N) that identifies the swimmer. In addition, the swimmer identification information and the first and second information input from the first and second sensor modules may be further stored in the memory.

Next, in the step of generating an event (S13), the swimmer state may be detected based on the generated swimmer information, and notification information related to the detected swimmer state may be generated to generate an event.

The foregoing notification information related to the swimmer state may include a swimming pool complexity notification, a warning notification based on detection of suitability for the swimmer height, a notification of the swimmer's elapsed period of time in the pool and rest guide, a risk warning notification based on detection of the swimmer's abnormal motion state, and notification information related to a specific game application, but is not limited thereto.

Next, the controlling of the generated event to be output to a display (S14) may include executing one or more applications or specific operations of the applications installed in the swimming pool system corresponding to the generated event. Additionally, the controlling of an application execution screen to be output to one or more display screens included in the display may be included, but is not limited thereto.

The foregoing present disclosure may be implemented as computer-readable codes on a program-recorded medium. The computer-readable medium may include any type of recording device in which data readable by a computer system is stored. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device and the like, and also include a device implemented in the form of a carrier wave (for example, transmission via the Internet). The computer may include the controller of the terminal. The detailed description is therefore to be construed in all aspects as illustrative and not restrictive. The scope of the present disclosure should be determined by reasonable interpretation of the appended claims and all changes that come within the equivalent scope of the present disclosure are included in the scope of the present disclosure.

1. A smart interaction system based on swimmer state monitoring, the system comprising:
a sensor module that senses a swimmer body part through a first sensor module above a water surface and a second sensor module below the water surface to acquire first and second information on the swimmer body part; and
a processor that fuses the first and second information input from the first and second sensor modules to generate one or more of position, height, gesture and motion information on a swimmer, and generate an event based on the generated information,
wherein the processor controls an application execution screen corresponding to the generated event to be output on a display.

2. The system of claim 1, wherein the first sensor module is arranged above the water surface to sense one or more swimmer body parts located above the water surface, and acquire first information including body part identification information of the sensed swimmer body parts, coordinate information (x, y), and distance information from the water surface to the body parts, and
wherein the second sensor module is arranged below the water surface to sense one or more swimmer body parts located below the water surface, and acquire second information including coordinate information (x, y) of the sensed swimmer body parts and distance information from a bottom surface of a swimming pool to the sensed body parts.

3. The system of claim 1, wherein the processor comprises a swimmer information generation module that fuses the first and second information input from the first and second sensor modules through a swimming sensor fusion algorithm to generate position, height, gesture and motion information on the swimmer including the sensed swimmer body parts, and
wherein the swimmer information generation module further generates swimmer identification information that identifies the swimmer.

4. The system of claim 3, further comprising:
a memory operatively coupled to the processor,
wherein the processor controls swimmer information including the generated position, height, gesture and motion information on the swimmer and the swimmer identification information to be stored in the memory.

5. The system of claim 4, wherein the processor further comprises:
a swimmer position monitoring module that monitors the position of the swimmer based on the swimmer information, and
a swimmer state detection module that detects a state of the swimmer based on a result of the monitoring and the swimmer information,
wherein the swimmer state detection module generates a predefined event based on the detected state of the swimmer, and
wherein the event comprises notification information generated based on the detected state of the swimmer.

6. The system of claim 5, further comprising:
a communication module operatively coupled to the processor,
wherein the processor controls notification information included in the event to be transmitted to a peripheral device through the communication module based on the generated event, and
wherein the peripheral device is at least one of electronic devices that control lighting, music and waves within the swimming pool.

7. The system of claim 2, wherein the first sensor module comprises at least one sensor among a lidar sensor and a radar sensor, and
wherein the type, number, and arrangement of the one or more sensors are determined based on a sensing range of the sensor provided in the first sensor module and a size of the swimming pool.

8. The system of claim 2, wherein the first sensor module calculates, when it is determined that the sensed body part is a head part of the swimmer based on body part identification information of the one or more sensed swimmer body parts, a swimmer head height, which is a distance from the water surface to the head part, calculates, when one or more other body parts are detected at a higher position than the head part, a swimmer peak height, which is a distance from the water surface to a highest body part, and further includes the calculated swimmer head height and swimmer peak height in the first information.

9. The system of claim 2, wherein the second sensor module is provided with at least one sensor among an optical sensor and an ultrasonic sensor, and
wherein the type, number, and arrangement of the one or more sensors are determined based on a sensing range of the sensor provided in the second sensor module and a size of the swimming pool.

10. The system of claim 9, wherein the second sensor module comprises:
a vertical measurement underwater sensor disposed in a vertical direction with respect to one or more display panels provided on the display to sense one or more swimmer body parts located in the vertical direction of the display panels;
a first inclination measurement underwater sensor disposed to be spaced apart from the vertical measurement underwater sensor and to be tilted in a first inclination angle direction so as to sense one or more swimmer body parts located in the first inclination angle direction; and
a second inclination measurement underwater sensor disposed to be spaced apart from the first inclination measurement underwater sensor and to be tilted in a second inclination angle direction so as to sense one or more swimmer body parts located in the second inclination angle direction, and
wherein the vertical measurement underwater sensor, and the first and second inclination measurement underwater sensors are arranged in parallel to form one or more lines between the display panels.

11. The system of claim 9, wherein the second sensor module acquires, when the one or more sensed body parts are sensed by the first and second inclination measurement underwater sensors, distance information from a bottom surface of the swimming pool to the sensed body part based on a distance from the first and second inclination measurement underwater sensors to the sensed body part and the first and second inclination angles.

12. The system of claim 5, wherein the swimmer state detection module counts a number of swimmers located in the swimming pool based on a result of the monitoring and the swimmer information, calculates a swimming pool complexity based on a result of the counting, and generates notification information including the calculated swimming pool complexity to generate a predefined event.

13. The system of claim 5, wherein whether the swimmer is located in a specific area of the swimming pool having a depth suitable for the swimmer's height is determined based on a result of the monitoring and the swimmer information, and notification information including swimmer identification information, position information of the swimmer, and a warning guidance message is generated based on a result of the determination to generate a predefined event.

14. The system of claim 5, wherein the swimmer state detection module determines whether the swimmer's stay period of time inside the pool exceeds a predefined suitable swimming period of time range based on a result of the monitoring and the swimmer information, and generates notification information including the swimmer identification information, position information, and a rest guidance message based on a result of the determination to generate a predefined event.

15. The system of claim 5, wherein the swimmer state detection module determines whether the motion information included in the swimmer information matches a predefined swimmer abnormal motion pattern based on a result of the monitoring and the swimmer information, and generates notification information including swimmer identification information, position information, motion information of the swimmer, and a risk guidance message based on a result of the determination to generate a predefined event, and
wherein the swimmer abnormal motion pattern comprises at least one of motion patterns of floundering, head submersion, full body submersion, and drowning in progress.

16. The method of claim 5, wherein the swimmer state detection module determines whether the motion information included in the swimmer information matches a predefined game-related motion pattern in one or more game applications installed in the swimming pool system based on a result of the monitoring and the swimmer information, and generates notification information including swimmer identification information, position information, motion information of the swimmer, and the game application information based on a result of the determination to generate a predefined event, and
wherein the predefined game-related motion pattern comprises a pattern in which a standing state of the swimmer, a jumping state, a state of waving his or her left or right hand, and a state of pressing a specific area where a game screen is displayed with his or her foot are detected in an area where the game screen of the game application is displayed.

17. The system of claim 1, wherein the display comprises a first display and a second display,
wherein one of the first and second displays is disposed in a form of a rooftop signage display, and
wherein the other one is disposed on a bottom surface of a swimming pool in a form of a flow signage display.

18. The system of claim 17, wherein the processor further comprises an application control module that executes an application or a specific function of an application corresponding to the event based on the generated event, and
wherein the application control module controls an execution screen of the application to be output to at least one display among the first and second displays provided in the display.

19. The system of claim 1, further comprising:
an audio output module that outputs a notification sound corresponding to notification information included in an event generated by the processor.

20. A method of controlling a smart interaction system based on swimmer
sensing a swimmer body part through a first sensor module above a water surface and a second sensor module below the water surface to acquire first and second information on the swimmer body part;
fusing the first and second information input from the first and second sensor modules to generate one or more of position, height, gesture and motion information on a swimmer;
generating an event based on the generated information; and
controlling an application execution screen corresponding to the generated event to be output on a display.
